(19) United States
(12) Patent Application Publication
(10) Pub. No.: US 2008/0121826 A1
(43) Pub. Date: May 29, 2008

(54) Laser source detection system and method

(75) Inventors: Jathan W. Manley, Blaine, MN (US); Jan Jelinek, Plymouth, MN (US)

Correspondence Address: HONEYWELL INTERNATIONAL INC., 101 COLUMBIA ROAD, P O BOX 2245, MORRISTOWN, NJ, 07962-2245, US

(73) Assignee: Honeywell International Inc., Morristown, NJ (US)

(21) Appl. No.: 11/272,527

(22) Filed: Nov. 11, 2005

Related U.S. Application Data
(63) Continuation-in-part of application No. 10/622,819, filed on Jul. 18, 2003, now Pat. No. 7,196,301.

(51) Int. Cl. H01J 40/14; H01J 5/16; H01J 3/14; G02B 27/00

(52) U.S. Cl. 250/551; 250/216

(57) ABSTRACT

A system and method for laser source detection. An exemplary embodiment of the system includes a first array of lenses, a second array of opto devices (including light sources and light detectors), and at least one processor. Energy from the light source may be detected at the array of opto devices having lenses at known positions, to allow the approximate location of the laser source to be determined. Upon determining the source, responsive action may be taken. If the incoming laser is from a friendly party, a friendly-party notification may be provided. If the incoming laser is from an enemy, reciprocal targeting or false reflections may be employed.

### CROSS REFERENCE TO RELATED APPLICATIONS

This continuation-in-part application claims the priority benefit of U.S. patent application No. 10/622,819 entitled “A MEMS Micro-Lens Based Approach To Locating Laser Sources” filed on Jul. 18, 2003. The above non-provisional application is hereby incorporated by reference in its entirety including all references cited therein.

### BACKGROUND

The present invention relates to laser source detection, and more particularly, to a system and method for laser source detection.

Modem weapons systems frequently use lasers to assist in targeting. Because the path of a laser beam is essentially a straight line, it can be used as a starting point for sighting a weapon, and adjustments may be made to compensate for gravity, wind, and other factors. Some weapons systems employ a beam-riding scheme, in which a munition, such as a missile, tracks the path of a laser beam to a target painted by the laser. One of the effects of laser-assisted targeting is improved accuracy and precision.

At the same time, a party painted by such a laser needs to be able to react in a quick and appropriate manner. Regardless of whether the source of the laser is an enemy or friendly party, the painted party needs to avoid any munitions that may be fired. If the source of the painting laser is a friendly party, the painted party will preferably be identified as a non-enemy, and no munitions will be fired. “Friendly-party notification” is becoming increasingly important, as friendly-fire incidents are making up increasingly larger percentages of total wartime casualties.

One approach similar to friendly-party notification is CIDDS (Combat IDentification Dismounted Soldier). In CIDDS, an interrogator set shines a laser on a target. If the targeted soldier is friendly and has a similar system, laser detectors will decode the signal and a radio transmitter on the targeted soldier responds with a coded message indicating he or she is friendly. This response message breaks radio silence, and thus, is a security risk. The CIDDS system is strictly a combat identification system, and does not detect or respond to lasers from range finders, battlefield illuminators, or target designator systems. The CIDDS helmet-mounted transponder is about 335 grams and has a range of approximately 1100 meters.

Another approach that provides a greater range (about 5500 meters ground-to-ground and 8000 meters air-to-ground), but is much heavier, is BCIS (Battlefield Combat Identification System). This vehicle-mounted system operates similarly to, but is not compatible with, CIDDS. Because communication responses are by radio, radio silence is broken. While BCIS is capable of identifying the source of a laser within a quadrant, it is still primarily a combat identification system, and does not detect or respond to lasers from range finding systems, battlefield illuminators, or target designator systems. Other similar systems, such as LWS-CV, also exist.

A technology that may improve laser detection capabilities is HARLID (High Angular Resolution Laser Irradiance Detector). While still primarily a prototype system, HARLID uses an array of detectors to locate the source of a laser within one degree (azimuth and elevation). However, HARLID is purely a detection system and provides no combat identification or reciprocal targeting capabilities. Raytheon's AN/VVR-1 Laser Warning Receiver may be an example of a HARLID-based system.

Other approaches have been developed to detect target designator, range finder, and beam rider threats, but actions taken upon detection (e.g. friendly-party notification) still suffer from shortcomings. To improve battlefield situation awareness, it would be desirable to accurately detect if a soldier or vehicle has been painted by a laser (e.g. range finder, target designator, beam rider, spotting beam, battlefield illuminator), locate the source of the laser, and provide friendly-party identification/notification. In addition, it would be desirable, in some embodiments, to provide reciprocal targeting to respond to imminent threats. The preferred solution should be relatively lightweight, easy-to-deploy, small, and interfaceable with existing systems, such as situation awareness systems (e.g. Objective Force Warrior displays and vehicle cockpit display systems) and target designators.

### SUMMARY

A system and method for laser source detection are disclosed. An exemplary embodiment of the system includes a first array of pre-positioned lenses, a second array of opto devices (including laser sources and laser detectors), and at least one processor. By measuring energy received at individual detectors in the array whose lens positions are known, the approximate location of the laser source may be determined. Upon determining the source, responsive action may be taken. If the incoming laser is from a friendly party, a friendly-party notification may be provided. If the incoming laser is from an enemy, reciprocal targeting may be used to allow a laser-guided munition to be fired. Alternatively, at least one laser may be transmitted in a plurality of directions to cause false reflections, in an attempt to break a lock maintained by an incoming laser-guided munition.

These as well as other aspects of the present invention will become apparent to those of ordinary skill in the art by reading the following detailed description, with appropriate reference to the accompanying drawings.

### BRIEF DESCRIPTION OF THE DRAWINGS

FIG. 1 is a simplified block diagram illustrating a system for laser source detection, according to an exemplary embodiment of the present invention;

FIG. 2 is a perspective pictorial diagram illustrating a system for laser source detection, according to an exemplary embodiment of the present invention;

FIG. 3A is a pictorial diagram illustrating a top view of a representative cell in a system for laser source detection, according to an exemplary embodiment of the present invention;

FIG. 3B is a pictorial diagram illustrating a side view of a representative cell in a system for laser source detection, according to an exemplary embodiment of the present invention;

FIG. 4A and 4B are pictorial diagrams illustrating placement of a system for laser source detection on military vehicles, according to exemplary embodiments of the present invention;

FIG. 5A and 5B are pictorial diagrams illustrating placement of a system for laser source detection on military personnel, according to exemplary embodiments of the present invention;

FIGS. 6A and 6B show a flow diagram illustrating a method for laser source detection, according to an exemplary embodiment of the present invention;

FIG. 7A is a pictorial diagram illustrating a two-dimensional cross-sectional side view of a system for laser source detection, according to an exemplary embodiment of the present invention;

FIG. 7B is a pictorial diagram illustrating a side view of a representative cell in a system for laser source detection, according to an exemplary embodiment of the present invention;

FIG. 8A is a pictorial diagram illustrating a two-dimensional cross-sectional side view of a system for laser source detection employing stationary cells, according to an exemplary embodiment of the present invention;

FIG. 8B is a pictorial diagram illustrating a side view of a representative cell in a system for laser source detection, according to an exemplary embodiment of the present invention; and

FIG. 9 is a pictorial diagram illustrating a representative surface of a system for laser source detection, according to an exemplary embodiment of the present invention.

### DETAILED DESCRIPTION OF PRESENTLY PREFERRED EMBODIMENTS

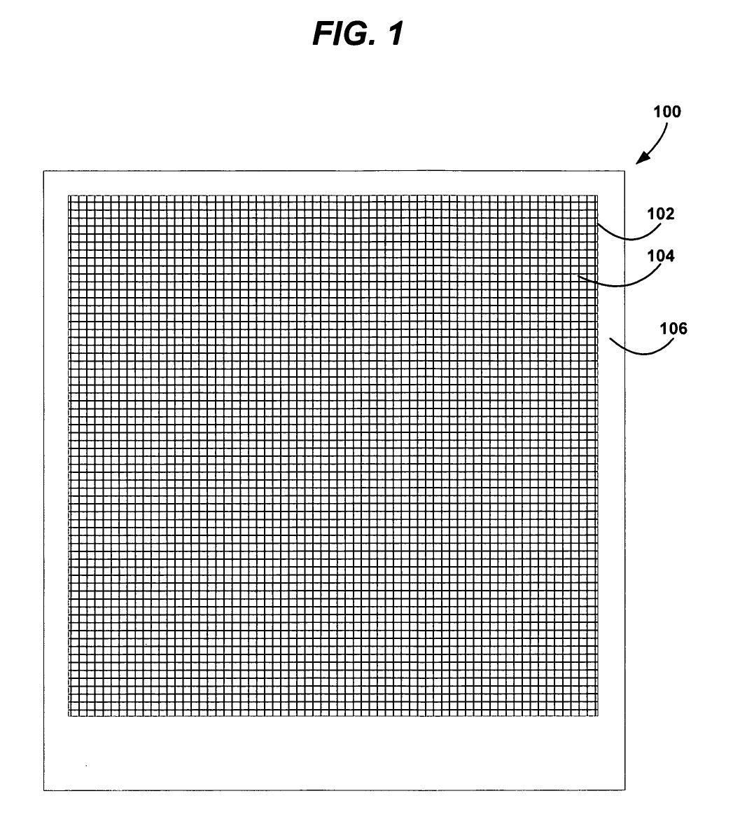

FIG. 1 is a simplified block diagram illustrating a system 100 for laser source detection, according to an exemplary embodiment of the present invention. The system 100 includes an array 102 of cells, such as cell 104. The system 100 is operable to detect a remote laser source based on energy incident of the system. Upon detecting the laser, the facility 106 upon which the array 102 is mounted can take appropriate responsive action, such as transmitting a communication (e.g. a friendly-party notification) to the laser source or taking defensive action (e.g. transmitting light back toward the source to break any lock that an incoming light-guided munition may have on the facility 106).

In a preferred embodiment, the array 102 comprises many (e.g. tens, hundreds, thousands or more) cells 104, with each cell being small (e.g. approximately 1 mm²), resulting in an overall array size of approximately 0.1 m² for use on military personnel to approximately 1 m² for use on military vehicles or installations). Smaller array sizes may be advantageous for portability and/or ease of placement, while larger array sizes will allow for more accurate laser source detection and location.

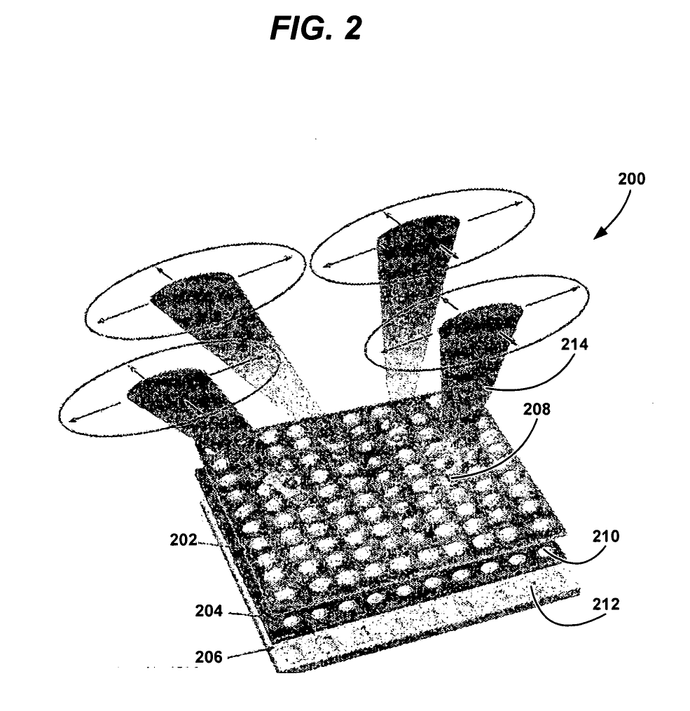

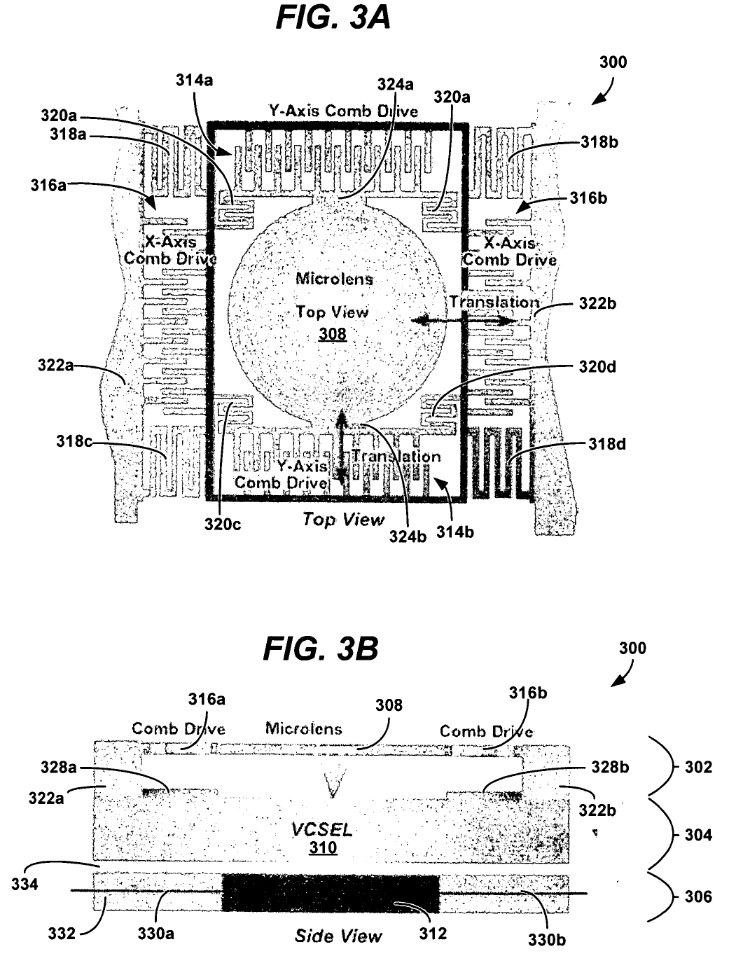

As described in detail in FIGS. 2, 3A, and 3B, the array 102 preferably includes cells 104 for detecting light as well as cells 104 for transmitting light. So configured, the system 100 is operable to detect and locate light, as well as transmit light back for communication and/or reciprocal targeting. Because transmitted communications are preferably composed of light signals, radio silence is not compromised, resulting in potentially safer conditions for the facility 106. Another advantage of using light instead of radio is it is less susceptible to jamming and spoofing. For purposes of convenience and to more accurately describe how embodiments of the invention are likely to be used in the field, the remainder of this detailed description will assume the light is from a laser source.

FIG. 2 is a perspective pictorial diagram illustrating a system 200 for laser source detection, according to an exemplary embodiment of the present invention. The system 200 includes a lens array 202, an opto device array 204, and a driver array 206 that includes one or more compute elements. The system 200 is also likely to include an interface (not shown) that may be used to connect the system 200 to other equipment, such as weaponry and communications and/or computing systems, for example.

The lens array 202 includes a plurality of lens array cells 208, with each cell 208 preferably including an integrated MEMS (Micro-Electro-Mechanical Systems) diffractive microlens and actuator for positioning the lens. Each cell is preferably about 1 mm², however other sizes may be used as well. A smaller cell size will allow for increased cell density and improved accuracy. Details of a preferred implementation of the cell 208 are presented in FIGS. 3A and 3B.

The opto device array 204 includes a plurality of opto device cells 210, with each cell 210 preferably including either an optical detector (such as a photodiode) or a light source, such as a laser. Each cell 210 in the opto device array 204 is preferably associated with a respective cell 208 in the lens array 202 to enable each microlens to operate in cooperation with its associated optical detector or light source.

The driver array 206 includes a plurality of driver cells 212 and provides power, communication, and computation functionality to the system 200. Power may be provided by connection to an external power source, such as a battery or solar cell array, or it may emanate from an integrated power source. Communications may be provided by a grid of connections linking the plurality of driver cells 212 to one another. In addition, the driver array 206 may provide one or more output signals to external equipment, such as weaponry or communication/computation equipment, for example. In addition to power and communications, the driver array 206 may provide the processing capability to perform computations for determining the location of a detected remote laser source and/or for positioning microlenses in the lens array 208 for to cause lasers in the system 200 to perform reciprocal targeting. In a preferred embodiment, the driver array 206 includes a plurality of distributed processors, rather than a single processor for the entire system 200. If each lens array cell 208 and associated opto device cell 210 has its own processor in its own associated driver cell 212, the computational burden is distributed throughout the entire array, resulting in simplified calculations and faster operation. The distributed processors may be implemented in any of several forms, including commercially available micro-processors (e.g. from IBM, HP, and others) or ASICs (Application Specific Integrated Circuits), for example. To allow the processors to perform calculations, a memory may be provided with each processor (or for use by a plurality of processors).

In a preferred embodiment, the system 200 is approximately between 0.1 m² for use on military personnel to approximately 1 m² for use on military vehicles or installations. Of course, smaller or larger implementations may be used to meet design goals, such as size, power draw, and/or accuracy. A larger implementation is likely to be more accurate at the expense of increased power consumption, while a smaller implementation will be more portable and lightweight. In addition, while the system 200 is shown as a single contiguous unit, it may alternatively be distributed less densely over a larger area. This may improve accuracy, but might sacrifice speed due to longer links between individual cells.

Because the system 200 is preferably constructed using MEMS hardware, it is lightweight and easy to deploy. Power consumption is minimal, with very little power consumption until a light source, such as a semiconductor laser, is deployed.

FIGS. 3A and 3B are pictorial diagrams illustrating top and side views, respectively, of a representative cell 300 in an apparatus for laser source detection, according to an exemplary embodiment of the present invention. The cell 300 includes a lens portion 302, an opto device portion 304, and a driver portion 306. Portions 302, 304, and 306 may be respective portions of arrays 202, 204, and 206 described with reference to FIG. 2.

The lens portion 302 includes a microlens 308, y-axis comb drives 314a and 314b, x-axis comb drives 316a and 316b, x-axis suspension members 318a-d, y-axis suspension members 320a-d, a base portion 322, and lens holders 324a and 324b. The representative cell 300 has an approximate size of 1 mm².

The structure of lens portion 302 may be realized through standard MEMS processing techniques, such as a series of silicon structuring steps including patterning and etching appropriate layers of silicon and oxides. The suspended lens arrangement may be constructed, for example by depositing an optically transparent material over a sacrificial layer, which is removed to produce the cavity through with the lens may focus light from a remote source or from an opto device contained in the opto device portion. In a preferred embodiment, the lens is approximately 0.1 mm in diameter and has a travel range of approximately 0.05 mm in the x- and y-directions, a resolution of approximately 0.0005 mm (0.5 μm), a speed of 5-10 kHz, a focal length of approximately 0.12/0.32 mm, and a refractive index of about 3.4.

A potential may be applied to the comb drives 314a-b and 316a-b to cause an electrostatic force to move the microlens 308 in the x- and y-axes. The final position of the microlens 308 may be determined through any of a number of techniques, such as by measuring the capacitance of the comb drives or by applying a sinusoidal wave voltage to the comb drives at the natural resonant frequency of the suspended microlens, so that its position may be calculated based on the applied voltage. Determining the position of the lens allows the cell 300 to be used to determine the location of the source of incoming light, or to confirm that outgoing light is accurately positioned.

The suspension members 318a-d and 320a-d allow movement of the microlens 308 along the x- and y-axes of the comb drives 314a-b and 316a-b. Although actuators and movement mechanisms have been described and illustrated for two perpendicular axes, other arrangements for movement and actuation may also be used.

The opto device portion 304 includes an opto device 310, and may include additional circuitry and/or connections to enable the opto device 310. Alternatively, some or all of the additional circuitry and/or connections may be located elsewhere, such as in the driver layer 306.

In the example of FIGS. 3A and 3B, the opto device is a semiconductor laser, namely, a VCSEL (Vertical Cavity Surface Emitting Laser). Other types of semiconductor lasers may be used, as may other types of light sources. Aperature 328a-b provides the opening for emitting laser energy. The microlens 308 is located at a sufficient distance from the opto device 310 (i.e. the VCSEL) to allow the emitted laser to be focused adequately.

Details on construction and operation of surface emitting lasers may be found, for example, in “Surface-emitting microlasers for photonic switching and interchip connections,” Optical Engineering, 29, pp. 210-214, March 1990. For other examples, note U.S. Pat. No. 5,115,442, by Yong H. Lee et al., issued May 19, 1992, and entitled “Top-emitting surface emitting laser structures,” and U.S. Pat. No. 5,475,701, by Mary K. Hibbs-Brenner, entitled “Integrated laser power monitor,” which are both hereby incorporated by reference. Also, see “Top-surface-emitting GaAs four-quantum-well lasers emitting at 0.85 mu.m,” Electronics Letters, 26, pp. 710-711, May 24, 1990. The laser described has an active region with bulk or one or more quantum well layers. The quantum well layers are interleaved with barrier layers. On opposite sides of the active region are mirror stacks formed by interleaved semiconductor layers having properties such that each layer is typically a quarter wavelength thick at the wavelength (in the medium) of interest thereby forming the mirrors for the laser cavity. There are opposite conductivity type regions on opposite sides of the active region, and the laser is turned on and off by varying the current through the active region. However, a technique for digitally turning the laser on and off, varying the intensity of the emitted radiation from a vertical cavity surface emitting laser by voltage, with fixed injected current, is desirable. Such control is available with a three terminal voltage-controlled VCSEL described in U.S. Pat. No. 5,056,098, by Philip J. Anthony et al., and issued Oct. 8, 1991, which is hereby incorporated by reference.

The opto device 310 may alternatively be a light detector, such as a photodiode. While a semiconductor laser, such as a VCSEL, may be used to transmit light out (e.g. for optical communication and/or reciprocal targeting), a light detector allows for detection of incoming light, and, in some embodiments, location of the source of the received light. The distance (i.e. the focal length) between the microlens 308 and the opto device 310 (i.e. the photodiode) is such that light passing through the microlens 308 is substantially focused onto the opto device 310. Then, as the microlens 308 is moved along the x- and y-axes, the light detector will be best able to determine intensity, which, in some embodiments, is used to determine the location of the source, as described in further detail below.

The driver portion 306 includes a processor 312, a connection 330a-b, a substrate 332, and a spacer layer 334. In some embodiments, more or fewer components may make up the driver portion 306.

The processor 312 is in communication with the lens portion 302 and the opto device portion 304 to provide control, calculation, and data acquisition functions. For example, the processor 312 may provide appropriate signals, such as through semiconductor traces or metallizations, to cause translation of the microlens 308 in the x- or y-axis and to determine lens position, as discussed above. Similarly, the processor 312 may control the opto device 310 (e.g. power-up the VCSEL or receive information from the photodiode). In determining the lens location at which the strongest energy is detected, four samples are preferably taken for each cell 300 to determine a vector toward the center of the laser energy seen by the cell 300.

The processor 312 for the cell 300 is shown as a single cell-based processor, rather than a processor serving many cells or even the whole array. While a processor could serve many cells in some embodiments, preferred implementations maintain the one processor per cell arrangement, to promote faster computation and control, as speed is essential in a battlefield context. In addition, the algorithms for determining lens position, calculating vectors for determining strongest energy locations, and determining the source of incoming light are preferably done in hardware to achieve faster and more robust results.

The connections 330a and 330b allow the processor 312 to communicate with processors in four neighboring cells. (See, for example, the neighboring cells and neighboring processors in the arrays shown in the system 200 of FIG. 2.) The processor 312, in turn, may also pass on information from all or some of its neighboring processors to each neighboring processor. As a result, every processor can obtain communications from every other processor in the array. Of course, information from cells containing photodiodes may be used for detecting light (and possibly location), while information from cells containing semiconductor lasers may be used for transmitting a focused column of light.

By receiving communications corresponding to many cells, the processor 312 can assist in determining the approximate location of a light source. In one embodiment, each processor stores a table of these observations. A partial example of such a table is shown below as Table A.

TABLE A

| NODE | ENERGY SEEN | LOCATION | WHEN |
|---|---|---|---|
| 425 | 1020 | 45.367° 121.24M | 12:00 01.0035 |
| 431 | 1044 | 45.380° 121.25M | 12:00 01.0102 |
| 418 | 989 | 45.388° 121.24M | 12:00 01.0199 |
| . . . | . . . | . . . | . . . |

In a preferred embodiment, tens of thousands of cells 300 are included in each array. When control is distributed over this many cells processing loads are distributed, errors are averaged, and greater fault-tolerance is realized. Of course, as MEMS technology improves fewer cells may provide similar performance.

Errors in location of a target, such as the source of received laser light may be due to errors in positioning the lens 308. Tangential (side-to-side) errors are likely to be very low, so that a target 1 km away could be located to within 1.0 m. The radial (distance away) error can be more significant, however. By including a large number of cells, average errors result in tighter bounds on the target location. Simple averaging of location estimates of pairs of cells is not likely to work, however, due to a highly skewed distribution of location estimates. To ease the computational burden, alternative coordinate systems, such as an angular coordinate system can be used, and the results can be converted to polar or Cartesian coordinates. In a preferred embodiment, the output of 10,000 pairs of cells 300 1 m apart includes a tangential location along with an estimated distance and confidence indicator (e.g. lower bound=967.57 m, upper bound=1034.68 m, confidence=95%).

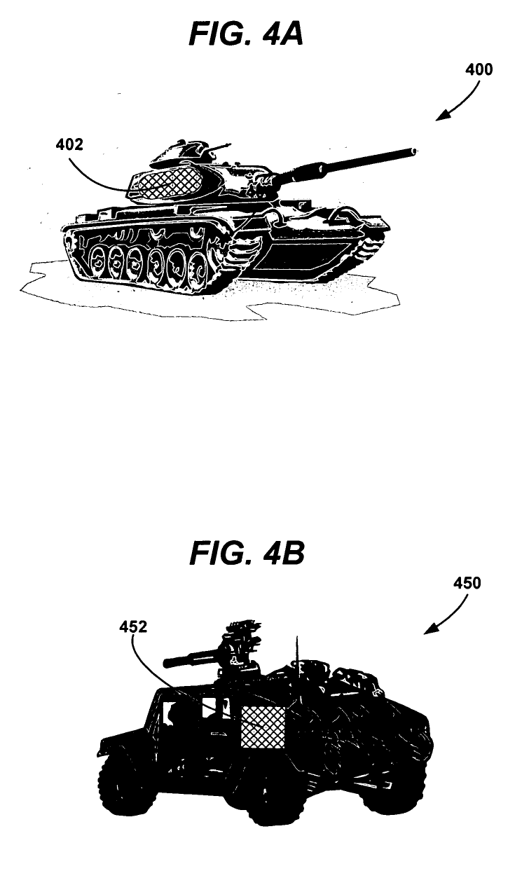

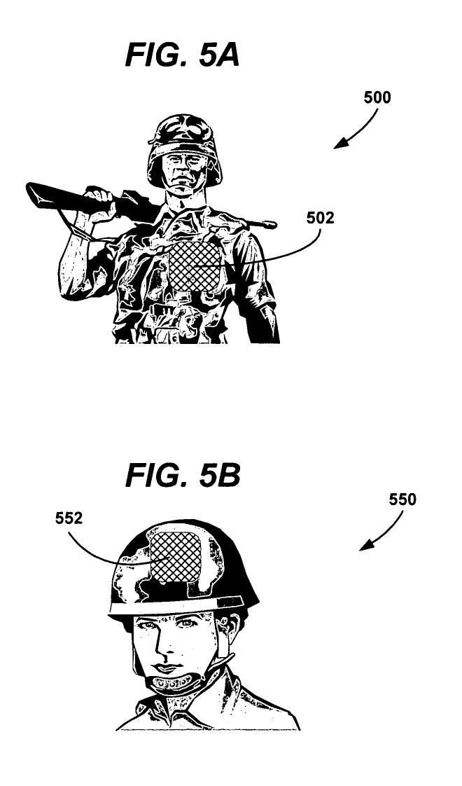

FIG. 4A and 4B are pictorial diagrams illustrating placement of systems 402 and 452 for laser source detection on military vehicles 400 and 450, according to exemplary embodiments of the present invention. FIG. 5A and 5B are pictorial diagrams illustrating placement of systems 502 and 552 for laser source detection on military personnel 500 and 550, according to exemplary embodiments of the present invention. The systems 402, 452, 502, and 552 may be similar to the system 200 shown in FIG. 2, utilizing cells like cell 300 in FIGS. 3A and 3B. Of course, a facility, such as a vehicle, is more likely to be able to accommodate a larger system than would a person. In a preferred embodiment, the system is implemented as a “patch” attached to a soldier or vehicle.

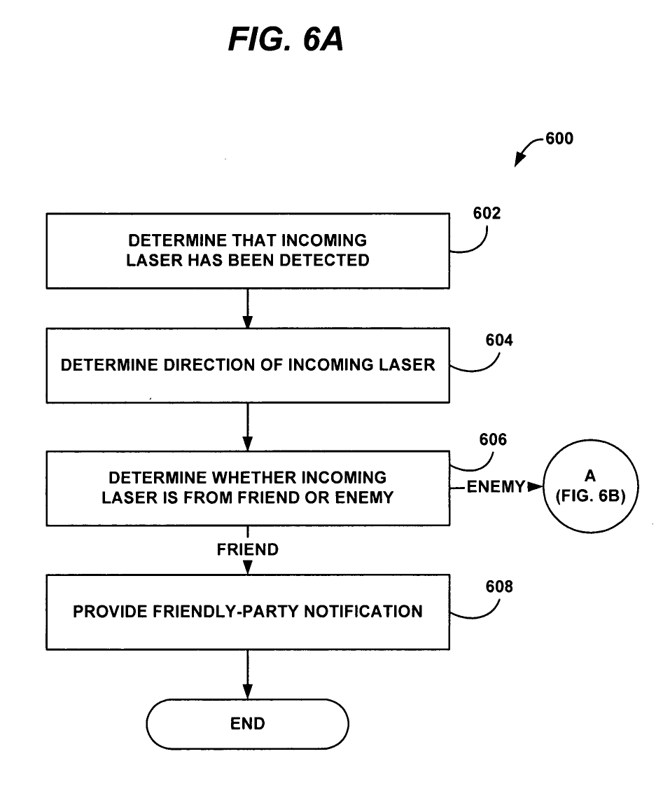

FIG. 6A and 6B show a flow diagram illustrating a method 600 for laser source detection, according to an exemplary embodiment of the present invention. In 602, the system determines that an incoming laser has been detected. In 604, the direction of the incoming laser is determined. In 606, a determination is made as to whether the incoming laser is from a friend or enemy. If the incoming laser is from a friend, then the system provides friendly-party notification, as shown in 608. If the incoming laser is from an enemy, then at least two options are available. According to a first option, the source of the incoming laser is targeted, as shown in 610. According to a second option, as shown in 612, the system transmits a laser in a plurality of directions to create a “false reflection.” The false reflection may cause an incoming munition having a laser lock to break its lock and miss the facility upon which the system is mounted.

The method 600 may make use of the system described in FIGS. 1-5B or it may make use of a different system. Detection of an incoming laser (block 602) may be accomplished using practically any laser detection scheme. Location of the laser source (block 604) may be done using computerized or manual techniques or a combination of the two. For example, the approach described with respect to FIGS. 1-5B may be used, in which an array of photodiodes receive light through an array of lenses and an array of communicating processors determines the location based on energy strength.

Determining whether an incoming laser is from a friend or enemy (606) is preferably accomplished by examining an optical code carried by the incoming laser and the wavelength of the laser. For example, identification may be based on a targeting code used by a designator. Some typical laser target designator codes include A-Code laser codes (AGM-114K Hellfire missile) and NATO STANAG No. 3733 codes. The codes specify the PRF (Pulse Repetition Frequency) of a laser emitter. Lower codes indicate a lower PRF, which allows for better target designation due to higher emitted power. The wavelength of the laser may be determined by having different detectors 310 in the array 200 tuned to be sensitive to different wavelengths.

Friendly-party notification (block 608) preferably comprises transmitting back an identification code (e.g. a combat ID) by laser. Known signaling techniques may be used, and one or more lasers may be used for signaling. In alternative embodiments, other means of providing friendly-party notification may be used, such as RF transmissions, visible light, or others.

Reciprocal targeting (block 610) may be performed using techniques similar to those used by typical laser designators. If the system of FIGS. 1-5B is used, the lenses overlying the semiconductor lasers should be translated to provide the desired intensity of laser light. The laser should be directed toward the target, as determined in block 604. Obviously, a system having a faster response time will be better able to provide location information for reciprocal targeting. Once reciprocal targeting has been employed, the source target can be targeted by a smart munition. For example, the laser can be used to guide a beam-riding munition.

In a preferred embodiment, false reflection (block 612) includes using a large number of lasers, such as the array of VCSELs shown in FIGS. 1-5B, to overwhelm and confuse an incoming laser-guided munition. Alternatively, and likely less effectively, a smaller number of lasers can be pulsed in different directions.

The blocks shown in FIGS. 6A and 6B may be performed in orders other than those shown. For example, determining the direction of an incoming laser (block 604) may be performed after determining whether the incoming laser is from a friend or enemy (block 606). Moreover, while a number of post-detection action sequences have been described, other similar sequences or combinations of sequences may be employed without departing from the intended scope of the application.

While the embodiment discussed above may be used to accurately calculate laser source position, it may be too slow to respond to target laser sources that are only detected for a short period of time. As an alternative to determining a laser source location by moving the cell detectors once laser light is detected, the detectors can be moved into various known positions before detecting a laser source.

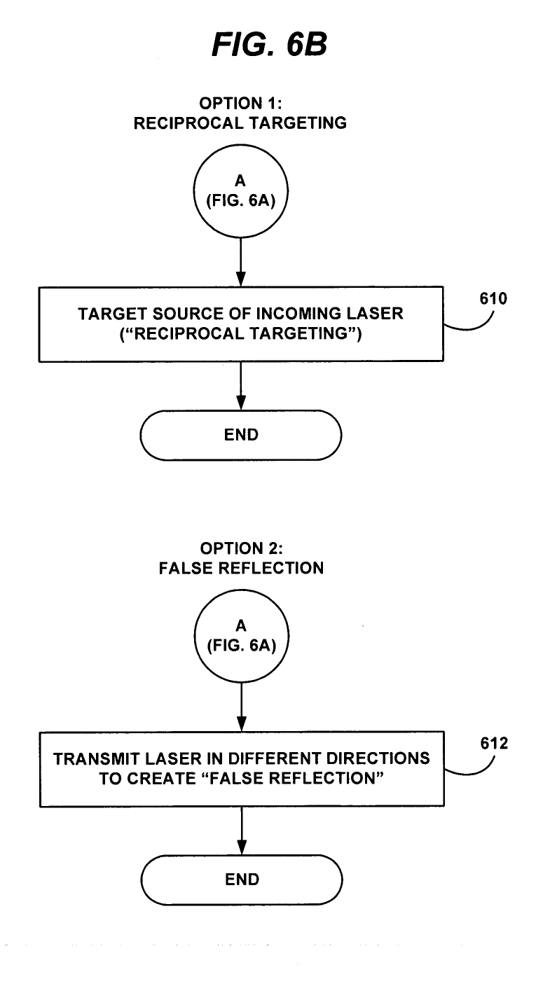

FIG. 7A is a pictorial diagram illustrating a two dimensional cross-sectional side view of a system 700 for laser source detection that utilizes pre-positioned detector cells. The preferred embodiment is a three dimensional system, but a two dimensional drawing is presented for illustrative purposes. FIG. 7B is a side view of one representative cell 702 in the system 700. In a preferred embodiment, the system 700 is a system for laser source detection that is similar in many respects to the array in the system 200 described in reference to FIG. 2. The system 700 consists of cells 702 that are similar to the representative cell 300 depicted in FIGS. 3A and 3B. The cells 702 preferably include a lens portion 302, an opto device portion 304, and a driver portion 306. In the cell 702, these portions preferably operate in the same manner as described in reference to FIGS. 3A and 3B. The lens portion 302 includes a MEMS drive and the opto device portion 304 includes an opto device 310, such as a photodiode.

Each cell 702 in the system 700 has a field of view 710. In a preferred embodiment, the cells 702 are preferably positioned such that the field of view 710 of a cell 702 looks in a predetermined and known position before attempting to detect a laser source. The cells 702 are preferably arranged in such a way that the field of view 710 of any individual cell is different from that of another individual cell. However, the cells 702 can be arranged in such a way that a field of view 710 of one cell 702 overlaps with the fields of view of multiple other cells 702. Even though each cell 702 is positioned such that each field of view 710 views a somewhat different spot before the detection of a laser source, any laser source shining on the system 700 will always be detected by a group of cells due to the overlapping fields of view of groups of cells.

Each cell 702 has a microlens 308, which has an optical axis 712. In a preferred embodiment, the optical axes 712 of adjacent cells 702 preferably tilt incrementally in fixed steps, such as the fixed step of i. The value of the amount of incremental tilt, such as i, can vary. The number of cells 702 with overlapping fields of view 710 will vary depending on the value of the incremental tilt. Alternatively, the tilts of the optical axes 712 of adjacent microlenses 308 do not have to be equal, as long as the field of view 710 of at least some cells 702 overlap.

When the system 700 is illuminated by a laser source, the energy from the light source is detected by the system 700. As described, any laser source is always detected by a group of cells 702 even though each cell 702 is positioned to view a somewhat different spot. In a preferred embodiment, the opto device 310 of the cell 702 is at a known offset from the optical axis 712 of the microlens 308. The offset may range from zero units to the angle of the field of view 710 of the lens. This offset can be determined by the system 700 because the microlens 308 of the cell 702 is at a known predetermined position before the system 700 detects a laser source. The offset can be determined by the driver portion 306 as described previously in reference to FIGS. 3A and 3B. Source intensity sensed by an opto device 310 drops off with an increasing incident angle of the laser source. The source intensity signal is strongest when the source lies on the detector cell's optical axis 712. Therefore, the system 700 can compute the direction and location of a laser source by using the relative energy levels measured by the cells 702 and the known offset of the opto device 308 from the optical axis 712 of the microlens. This calculation can be performed by the driver portion 306 of the system 700 as described above in reference to FIGS. 3A and 3B.

As yet another alternative, it is not necessary that the cells 702 of the system 700 remain stationary looking in the predetermined positions at all times. The accuracy of the laser source detection system improves when more cells detect the incoming laser source. This is true because more data leads toward less error in the source location calculation. When a laser source is detected by the system 700, typically not all of the cells 702 of the system 700 will detect the laser source. Therefore, while the system 700 is detecting a laser source, some of the pre-positioned cells 702 will not be in use (i.e. detecting). Some of these cells 702 that are not in use can be re-positioned by the driver portion 306 to look in different directions while the system 700 is detecting light. Re-positioning at least some of the non-detecting cells in order to detect the incoming laser source will lead toward increased accuracy in the laser source location calculation.

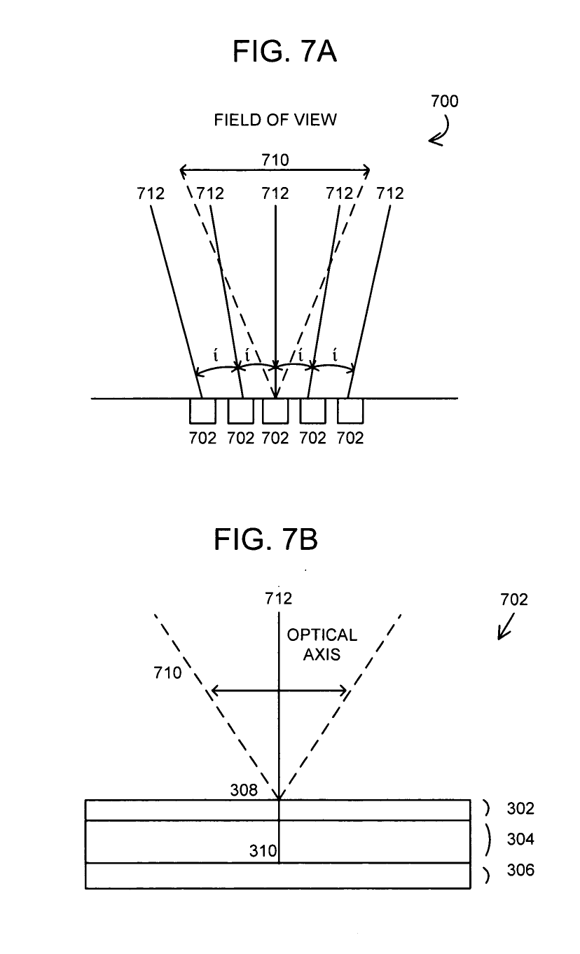

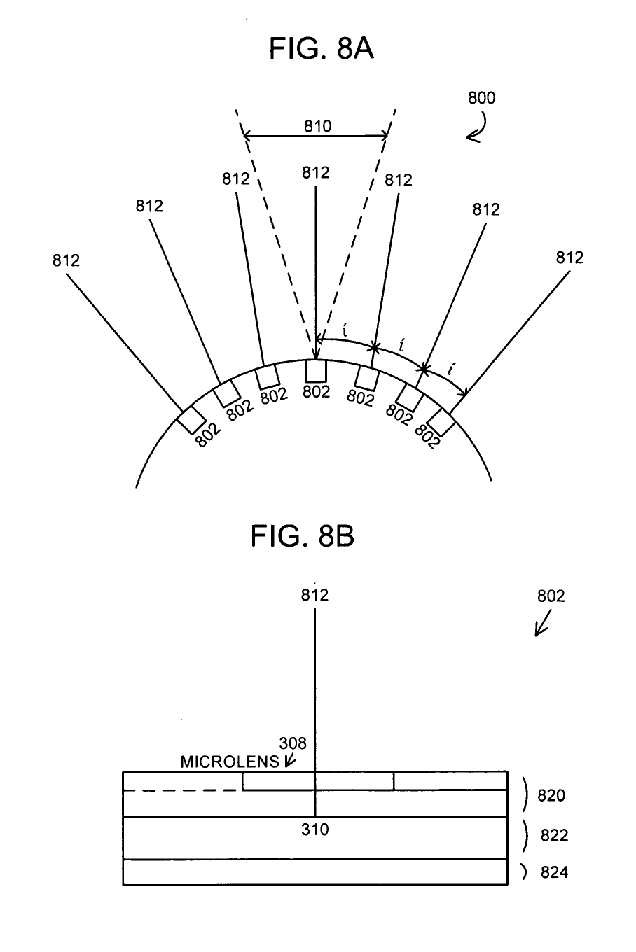

While the laser source detection system utilizing MEMS drives described above may be used to accurately detect the source of an incoming laser, both the cost and complexity of manufacturing these MEMS drive laser detection devices may be a disadvantage. FIGS. 8A, 8B, and 9 show an alternative embodiment in which the lenses and detectors are manufactured at stationary positions. FIG. 8A is a pictorial diagram illustrating a two dimensional depiction of a laser source detection system 800 that employs stationary cells 802. The preferred embodiment is a three dimensional object, but a two dimensional drawing is presented for illustrative purposes. FIG. 8B is a side view of one representative cell 802 in the system 800. FIG. 9 is a pictorial diagram illustrating a representative dome shaped surface 900 of a preferred embodiment in which the lenses and detectors are manufactured at stationary positions on the surface.

In a preferred embodiment, the system 800 is a system for laser source detection that is similar in many respects to the system 200 described in reference to FIG. 2. The system 800 consists of cells 802 that are similar to the representative cell 300 depicted in FIGS. 3A and 3B. The cells 802 however have stationary microlenses and do not require a MEMS drive device in order to move the microlenses. Therefore, the lens portion of the cells 802 differs in this respect from the lens portion detailed in FIGS. 3A and 3B.

The system 800 consists of an array of stationary cells 802. In a preferred embodiment, the cells 802 are placed on a generally spherical surface. This surface of a preferred embodiment is shown in FIG. 9 as a dome shaped surface. Alternatively, the system 800 could be another geometrical shape, such as a non-spherical geometrically shaped object. Each cell 802 in the system 800 has a field of view 810 and a microlens 308 with an optical axis 812. The stationary cells 802 are preferably positioned on the surface in such a way that the field of view 810 of any individual cell 802 is different from another cell. However, each cell 802 can be arranged on the surface in such a way that the field of view 810 of one cell 802 overlaps with the fields of view 810 of multiple other cells 802. By pointing adjacent cells 802 in slightly different directions on the generally spherically shaped surface of the system 800, it is possible to make the fields of view 810 of some cells 802 overlap. If equally spaced on a spherical surface, the optical axes 812 of the adjacent microlenses 308 of the cells 802 will tilt incrementally in fixed steps, such as the fixed step of i.

The cells 802 comprise a lens portion 820, an opto device portion 822, and a driver portion 824. As discussed above, the lens portion 820 comprises a microlens 308 but not a MEMS drive device. The opto device portion 822 and the driver portion 824 are preferably similar to the analogous portions described in reference to FIG. 3B. The opto device portion 822 comprises an opto device 310, such as a photodiode that is capable of detecting laser illumination. In a preferred embodiment, the position of the detector opto device 310 behind a microlens 308 is fixed and at a known offset from the optical axis 812 of the microlens 308. This offset may range from zero units to the angle of the field of view 810 of the microlens 308.

When the system 800 is illuminated by a light source, the energy from the light source is detected by the system 800. Due to the overlapping fields of view 810 of groups of cells 802, any laser source is always detected by a group of cells 802 even though each cell is positioned to a somewhat different spot. Source intensity sensed by the opto device 310 drops off with the increasing incident angle of the laser source. Therefore, the system 800 can compute the direction and location of a laser source by using the relative energy levels measured by the cells 802 and the known offset of the opto device 310 from the optical axis 812 of the microlens 308. This calculation can be performed by the driver portion 824 of the system 800 as described in reference to FIGS. 3A and 3B. The driver portion 824 includes a processor, a connection, a substrate, and a space layer. The processor is in communication with the lens portion 820 and the opto device portion 822 to provide calculation and data acquisition functions. By receiving communications corresponding to many cells, the processor can assist in determining the approximate location of a light source.

In a preferred embodiment, the cells 802 may be manufactured close together on the surface of the system 800. Placing cells 802 closer together on the geometrically shaped surface can lead toward more cells having overlapping fields of view 810. Increasing the number of cells 802 with overlapping fields of view 810 consequently improves the accuracy of the laser location calculation.

Preferred embodiments of the present invention have been illustrated and described. It will be understood, however, that changes and modifications may be made to the invention without deviating from the spirit and scope of the invention, as defined by the following claims.

1. A method of determining a source position of an incoming light source, comprising:
a. translating a plurality of microlenses to a plurality of known lens positions;
b. detecting energy from the incoming light source through the plurality of microlenses on a corresponding plurality of opto devices;
c. determining an estimate of direction of the incoming light source relative to the opto devices based on the detected energy at each of the plurality of opto devices.

2. The method of claim 1, wherein at least two of the opto devices are photodiodes.

3. The method of claim 1, wherein determining the estimate of direction includes determining an approximate location of the source.

4. The method of claim 1, wherein translating a plurality of microlenses to a plurality of lens positions comprises translating the plurality of microlenses with an actuator.

5. The method of claim 1, wherein translating a plurality of microlenses to a plurality of lens positions is performed prior to detecting the incoming light source.

6. The method of claim 1, wherein translating a plurality of microlenses to a plurality of lens positions prior to detecting a light source comprises translating the plurality of microlenses such that the microlenses are positioned in a manner such that any incoming light source received will always be received by at least two microlenses in the plurality of microlenses.

7. The method of claim 1, wherein determining an estimate of direction is performed by at least one processor associated with the plurality of microlenses and the plurality of opto devices.

8. A method of determining a source position of an incoming light source, comprising:
a. translating a plurality of microlenses to a plurality of known lens positions;
b. detecting energy from the incoming light source through the plurality of microlenses on a corresponding plurality of opto devices;
c. determining an estimate of direction of the incoming light source based on the detected energy at each of the plurality of opto devices wherein each microlens has an optical axis, and wherein determining an estimate of direction comprises:
determining offsets of the optical axes of the microlenses from the corresponding opto devices;
using the detected energy levels of the incoming light source and the offsets of the optical axes of the microlenses from the corresponding opto devices in order to determine an estimate of direction.

9. A method of determining a source position of an incoming light source comprising:
a. translating a plurality of microlenses to a plurality of known lens positions;
b. detecting energy from the incoming light source through the plurality of microlenses on a corresponding plurality of opto devices;
c. determining an estimate of direction of the incoming light source based on the detected energy at each of the plurality of opto devices; and
d. after initially receiving energy from the incoming light source through a plurality of microlenses on a corresponding plurality of opto devices, translating at least one of the microlenses not initially receiving a threshold amount of energy from the incoming light source to a lens position such that that threshold amount of energy is received through at least one of the microlenses not initially receiving the threshold amount of energy from the incoming light source.

10. A method of determining a source position of an incoming light source, comprising:
a. receiving energy from the incoming light source through a plurality of microlenses on a corresponding plurality of opto devices;
b. determining an amount of the energy detected by at least two of the opto devices; and
c. determining an estimate of direction from which the light source is incoming using the determined amount of energy detected.

11. The method of claim 10, wherein determining the estimate of direction includes determining an approximate location of the source.

12. The method of claim 10, wherein the stationary microlenses have optical axes at known offsets.

13. The method of claim 12, wherein determining an estimate of direction comprises providing the determined amounts of energy and the known offsets to a processor.

14. The method of claim 10, wherein at least two of the plurality of opto devices are photodiodes.

15. The method of claim 10, wherein determining an estimate of direction is performed by a plurality of processors associated with the plurality of stationary microlenses and the plurality of stationary opto devices.

16. The method of claim 10, wherein each stationary opto device corresponding to a stationary microlens is capable of detecting an incoming light source within a particular field of view, wherein a first field of view of a first stationary opto device corresponding to a first stationary microlens overlaps with a second field of view of a second stationary opto device corresponding to a second stationary microlens.

17-23. (canceled)
